(19) United States
(12) Patent Application Publication
(10) Pub. No.: US 2003/0020634 A1
(43) Pub. Date: Jan. 30, 2003

(54) Method for highway congestion management using dynamic paid upgrade for automobiles to use fast lanes

(75) Inventors: Dwip N. Banerjee, Austin, TX (US); Rabindranath Dutta, Austine, TX (US); Kamal Chandrakant Patel, Cedar Park, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/915,666

(22) Filed: Jul. 26, 2001

(51) Int. Cl. G08G 1/00

(52) U.S. Cl. 340/928; 340/5.4; 340/5.42; 705/13

(57) ABSTRACT

A method, program, and system for managing traffic flow on a road system are provided. The invention comprises associating a user fee with a particular lane on a road, monitoring all vehicles within the lane, and charging the user fee to all vehicles within the lane. In one embodiment, monitoring vehicles within the designated lane is done by means of radio frequency A identification (RFID) readers which interrogate transponders within a vehicle and identify the driver or vehicle. The driver/vehicle is associated with a user account and the user fee is charged directly to the account.

### BACKGROUND OF THE INVENTION

1. Technical Field

The present invention relates generally to wireless identification and payment technology, and more specifically to relieving road congestion by charging drivers for using designated express lanes.

2. Description of Related Art

Road congestion continues to be a growing problem as the number of vehicles continues to increase. The major source of road congestion lies in the fact that the road system is a subsidized government good which is supplied to the public under cost, ensuring that demand exceeds supply.

Ideally, drivers should be able to decide what they value more: the use of specific road space at a particular time, or the money they would have to pay to use that road space. The price would of course be determined by other drivers who would also like to use that same limited road space at that time. Obviously, not everyone can use the same limited space at the same time. Therefore, the more people that want to use the road space at a given time, the higher the price a driver will have to pay to bid limited road space away from other potential users. At other times (e.g. 3 AM) very few people might want to use the roads. In such a case, the price needed to bid the road space away from competing drivers would be very low, or nil.

The present public road system does not allow drivers to pay for the privilege of using limited road space to the exclusion of other drivers. Public financing of roads is done largely through gasoline taxes. However, these taxes are not directly related to road use at any given time, and they do not fully cover the costs of using and maintaining the road system. Drivers do not bear the full costs of using the roads. Therefore, use of the roads is supplied to drivers at a considerable discount compared to a free pricing system.

Without a pricing system that allows consumers (drivers) to bid against each other for scarce resources (road space) based on the consumers' respective utilities, there is no way of allocating road space to its most valued use and giving priority to those drivers who value the road space most highly at a given time. The result is a demand that far exceeds the supply of available road space, and subsequent over-utiltization (congestion) of the roads.

Therefore, it would be desirable to have a method for relieving road congestion by charging a premium price for the right to use designated express lanes, especially during periods of heavy demand.

### SUMMARY OF THE INVENTION

The present invention provides a method, program, and system for managing traffic flow on a road system. The invention comprises associating a user fee with a particular lane on a road, monitoring all vehicles within the lane, and charging the user fee to all vehicles within the lane. In one embodiment, monitoring vehicles within the designated lane is done by means of radio frequency identification (RFID) readers which interrogate transponders within a vehicle and identify the driver or vehicle. The driver/vehicle is associated with a user account and the user fee is charged directly to the account.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a schematic diagram illustrating a RFID network in which the present invention may be implemented;

FIG. 2 depicts a block diagram of a data processing system that may be implemented as a server in accordance with a preferred embodiment of the present invention;

FIG. 3 depicts a schematic diagram illustrating the relationship between RFID components in accordance with the present invention;

FIG. 4 depicts a schematic diagram illustrating the functional components of a transponder tag in accordance with the present invention;

FIG. 5 depicts a diagram illustrating the organization of highway lanes according to price differentials in accordance with the present invention;

FIG. 6 depicts a flowchart illustrating the process of tracking and charging a vehicle using a priority lane in accordance with the present invention; and

FIG. 7 depicts a flowchart illustrating the process of calculating user fees for the express lane in accordance with the present invention.

### DETAILED DESCRIPTION OF THE PREFERRED EMBODIMENT

With the maturing of wireless technologies and Radio Frequency Identification (RFID), as well as In Vehicle Information Systems (IVIS), it is becoming more feasible to charge motorists dynamically and instantly for renderable services. RFID has already been successfully applied to toll collections and security systems. The present invention provides a method and system for highway congestion relief by allowing automobiles to use prioritized lanes for a premium price.

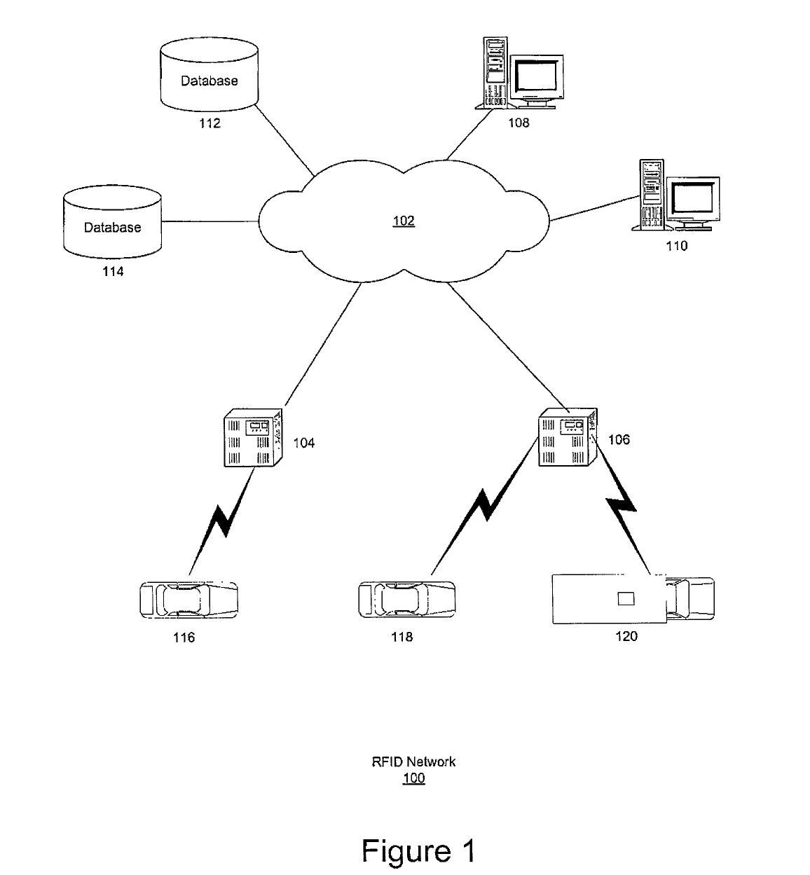

FIG. 1 depicts a schematic diagram illustrating a RFID network in which the present invention may be implemented. RFID network data processing system 100 contains a network 102, which is the medium used to provide communications links between various devices and computers connected together within RFID network data processing system 100. Network 102 may include connections, such as wire, wireless communication links, or fiber optic cables.

In the depicted example, servers 108 and 110 are connected to network 102 along with storage units 112 and 114. In addition, RFID readers 104 and 106 also are connected to network 102. These readers 104 and 106 may, for example, be placed proximal to highway lane or connected to antenna that are embedded in road surfaces. Readers 104 and 106 identify passing vehicles 116, 118, and 120 by interrogating transponder tags (not shown) in the vehicles. Readers 104 and 106 are clients to servers 108 and 110. Network data processing system 100 may include additional servers, clients, and other devices not shown.

In the depicted example, network 102 might be a worldwide collection of networks and gateways that use the TCP/IP suite of protocols to communicate with one another. At the heart of network 102 is a backbone of high-speed data communication lines between major nodes or host computers, consisting of thousands of commercial, government, educational and other computer systems that route data and messages. Of course, RFID network data processing system 100 also may be implemented as a number of different types of networks, such as for example, an intranet, a local area network (LAN), or a wide area network (WAN). FIG. 1 is intended as an example, and not as an architectural limitation for the present invention.

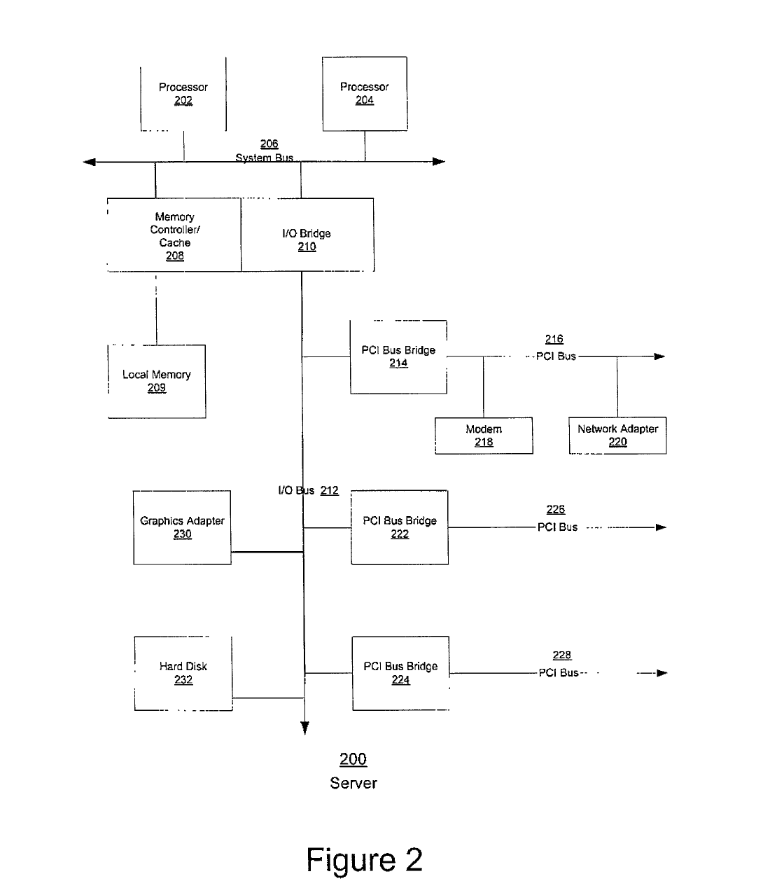

Referring to FIG. 2, a block diagram of a data processing system that may be implemented as a server, such as servers 108 and 110 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an eSeries pServer system, a product of International Business Machines Corporation in Armonk, N.Y., running the Advanced Interactive Executive (AIX) or Linux operating systems.

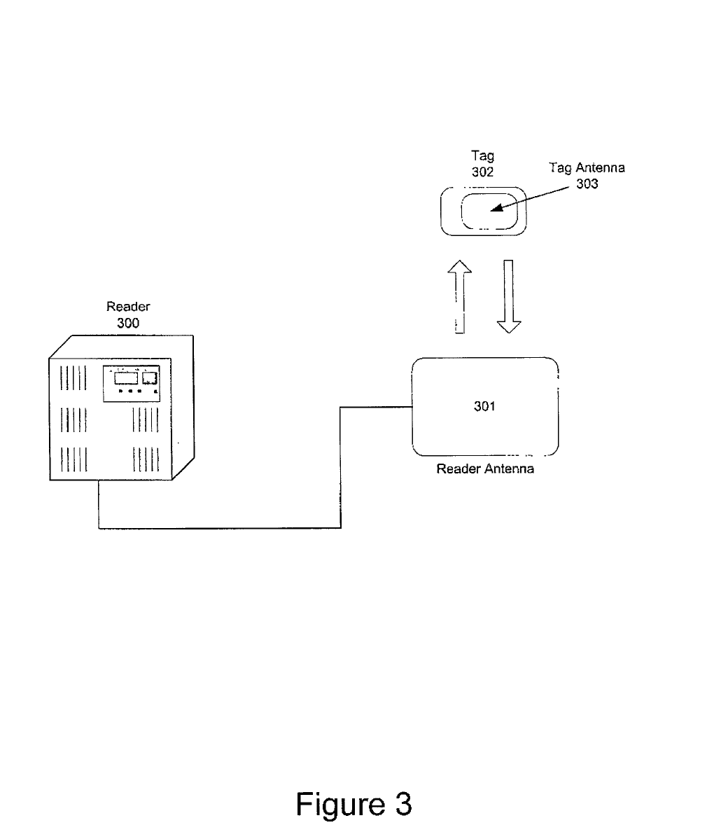

Referring to FIG. 3, a schematic diagram illustrating the relationship between RFID components is depicted in accordance with the present invention. RFID systems carry data in suitable transponders, such as transponder tag 302. Data within tag 302 may include, for example, personal/vehicle identification and account information. In addition to transponders tags, RFID systems need a means of reading/interrogating the tags, and some means of communicating such data back to a host computer. In the present example, reader 300 interrogates tag 302 by means of reader antenna 301 and reports this data back to server 108 and/or server 110 via network 102. Tag 302 responds, by means of antenna 303, to transmitted requests for data from reader 300. The mode of communication between reader 300 and tag 302 is by wireless means.

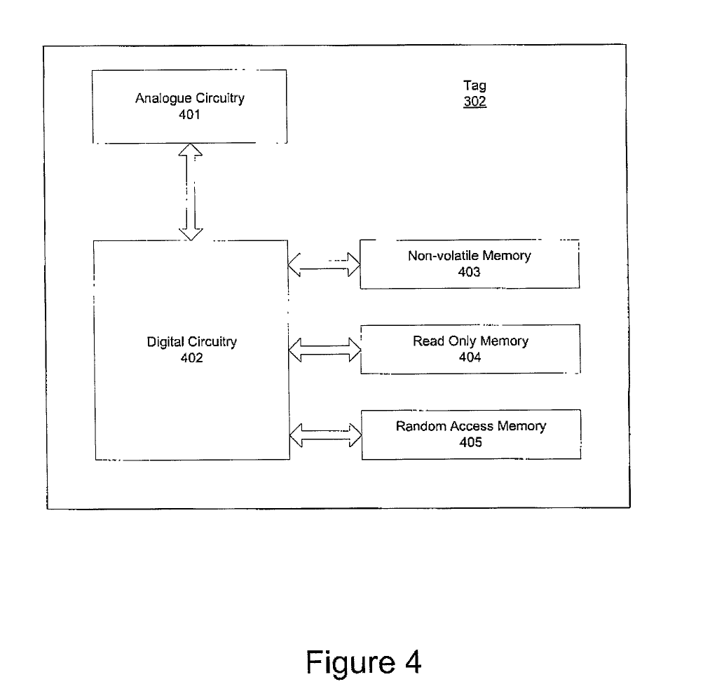

Referring to FIG. 4, a schematic diagram illustrating the functional components of transponder tag 302 is depicted in accordance with the present invention. The basic components of tag 302 may be fabricated using “coil-on-chip” technology. Analogue circuitry 401 provides for data transfer and power supply. Digital circuitry 402 includes control logic, security logic, and internal micro processing.

The tag memory can include nonvolatile memory 403, read only memory (ROM) 404, and random access memory (RAM) 405. Nonvolatile programmable memory (flash) 403 is used to store transponder data and ensures that the data is retained when tag 302 is in its power-saving “off” state. ROM 404 accommodates security data and the transponder operating system instructions which deals with internal house keeping functions such as response delay timing, data flow control, and power supply switching. RAM 405 temporarily stores data during interrogation and response by reader 300.

Transponder tag antenna 303 is the means by which tag 302 senses an interrogating field and serves as the means of transmitting the transponder response to an interrogation.

Those of ordinary skill in the art will appreciate that the depictions in FIGS. 3 and 4 are very simple and that the hardware may vary considerably depending on the needs of the user. The depicted example is not meant to imply architectural limitations with respect to the present invention.

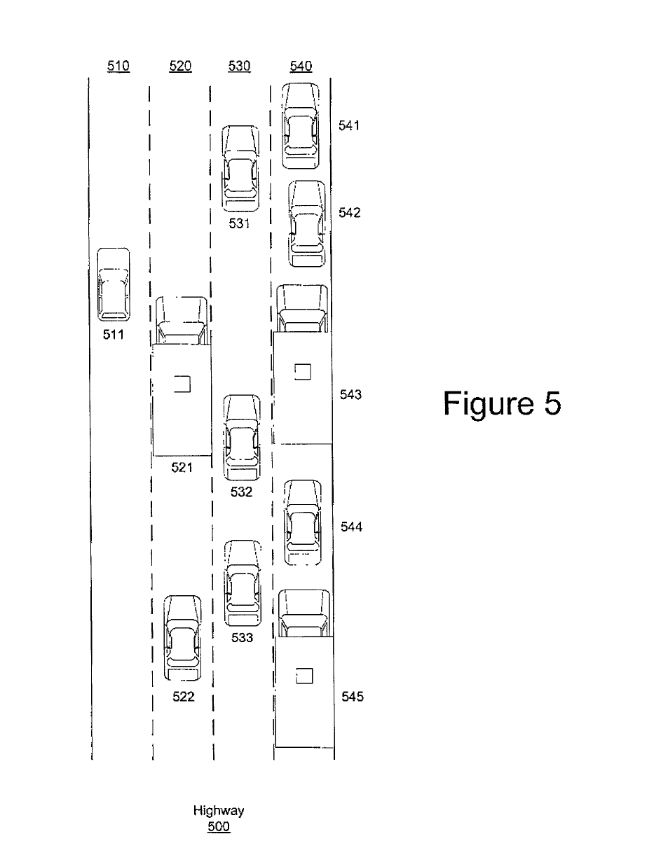

Referring now to FIG. 5, a diagram illustrating the organization of highway lanes according to price differentials is depicted in accordance with the present invention. In the present example, the highway 500 is divided into four lanes 510, 520, 530, and 540, each with a corresponding use fee. The exact price differential between the four lanes 510, 520, 530, and 540 will depend on the needs of the user (i.e. administrator or owner) and will likely vary under different circumstances, as explained below. For the purposes of the present example, lane 540 has no direct user fee and is therefore the “free” lane. Each lane to the left, from 530 to 510, has a progressively higher user fee associated with it, lane 510 having the highest user fee. It should be emphasized that highway 500 is merely an example. Some roads may only use one express lane with a direct user fee. Other roads might have multiple express lanes but charge the same user fee for all express lanes. Other roads may have a price scheme that changes dynamically to accommodate different conditions, as explained below.

The result of implementing the present invention is different levels of traffic flow from one lane to the next, corresponding to the different user fees associated with each lane. In the present example, lane 540 will have the greatest amount of traffic flow because there is no direct user fee for driving in that lane. By contrast, lane 510 will have the lowest level of traffic due to its relatively higher price. Traffic flow in lanes 520 and 530 will fall somewhere in the middle. Drivers using lane 540 will do so because they value their saved money (from not having to pay a direct fee) more than the reduced travel time they could have by using a more expensive lane. Those using lane 510 will do so because they value the faster travel time and reduced traffic flow than the money paid.

In the present example, RFID reader antennae are embedded in the road surface. The RFID antennae in each lane are connected with RFID readers that are assigned to that lane. A given reader may have several associated antennae within a road lane. The separate readers for a given lane collect identification data from transponder tags in vehicles traveling that lane. This data is then relayed back to a network server, which combines the data from the several readers concerning the same vehicle.

Referring to the vehicles in FIG. 5, when car 511 enters lane 510, the reader antennae in lane 510 interrogate the transponder in car 511 and identify the driver/vehicle. This data is sent to the network server, as explained above. The user fees for highway 500 might be based on a specified distance interval, e.g. 5¢ every 10th of a mile. Therefore, a reader antenna would be placed every 10th of a mile along the length of lane 510. When car 511 enters lane 510, it will pass over a reader antenna and incur a 5¢ charge every 10th mile it travels along lane 510. When car 511 leaves lane 510, it will no longer pass over the reader antennae for lane 510 and will no longer be charged the user fee associated with lane 510.

To prevent interference between reader antennae in adjacent lanes, the antennae should be placed in the center of each lane and use a limited transmission range. Dealing with interference between RFID readers and transponders is well known within the RFID field and is not the subject of the present invention.

It should be pointed out that the placement of RFID reader antennae within the road surface is merely one example of implementing the RFID technology. Readers and antennae may be placed in other locations relative to the road (e.g. Tollbooths, on and off ramps) and at different intervals. Those of ordinary skill in the art will recognized that there are many ways in which the RFID components may be physically arranged relative to each other and the road. In addition, the transponder tags used by vehicles may also take many forms, from tags which are adhered to windshields, to components which are built into the vehicle's onboard systems during manufacture.

Other alternatives for tracking vehicles within express lanes include LoJack technology and PageTrack 2. LoJack consists of a small, silent transmitter installed in a hidden place within a vehicle. It is used primarily for law enforcement, allowing police to track stolen vehicles. PageTrack 2 allows control of a vehicle from any personal computer that has Internet access. PageTrack 2 can also be customized to automatically send a command to track a vehicle at scheduled time increments, using “reflex” technologies, including: GPS, Internet, and digital two-way page messaging. The technologies represented by products such as LoJack and PageTrack 2 demonstrate the diversity of technical approaches that may be employed to detect and track vehicles. Such technologies may be used with the present invention as part of the fee collection process or for enforcement against vehicles that do not have required transponder tags.

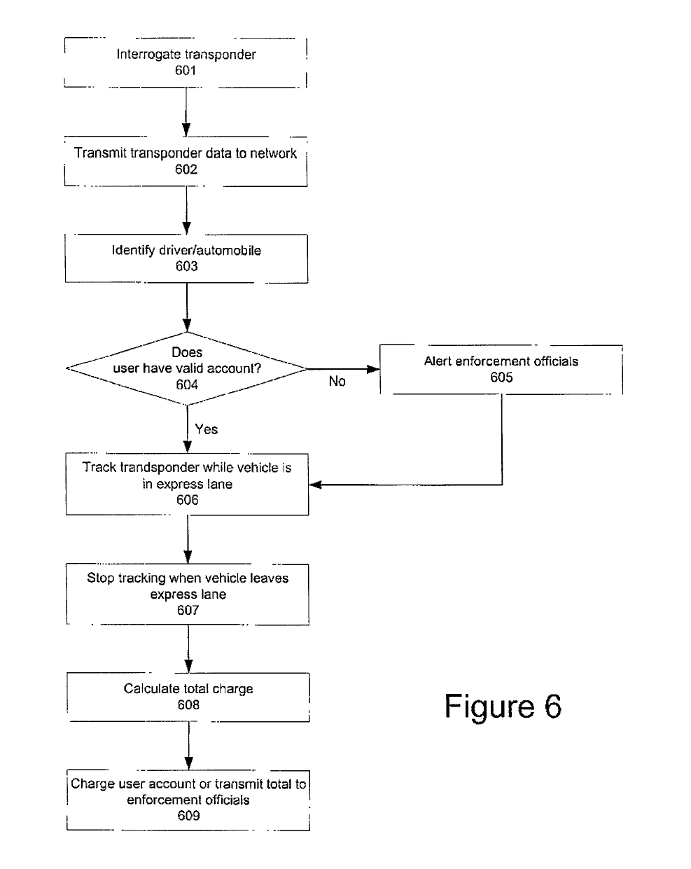

Referring now to FIG. 6, a flowchart illustrating the process of tracking and charging a vehicle using a priority lane is depicted in accordance with the present invention. When a vehicle enters a priority lane with an associated user fee, a RFID reader interrogates a transponder within the vehicle (step 601). The data received from the vehicle transponder is then sent back to a network server (step 602) which identifies the driver/automobile by means of a database lookup (step 603). The server determines if the driver has a valid account which can be charged (step 604). The account might be a credit/debit card or a special account with the road system provider. If the driver does not have a valid account, the system immediately notifies the proper law enforcement officials (step 605). Enforcement officials would also be notified in the case where a vehicle does not have a transponder tag at all. In such a case, the vehicle would have to be detected and tracked using alternate means. Examples include variations of the LoJack and PageTrack systems described above, or similar technologies. Other alternatives include video cameras at specified intervals, or low-power radar units, similar to police radar. These alternative detection and tracking technologies can be coordinated with the primary RFID components to provide backup when dealing with unauthorized lane use.

The system tracks the vehicle while the vehicle is in the priority/express lane (step 606). As explained above, this may be done by placing sensors at predetermined intervals along the road. However, other methods of tracking may be employed. When the vehicle leaves the express lane, the sensors associated with the lane stop tracking the vehicle (step 607). The system then calculates the total charge according to the total distance the vehicle traveled within the express lane, as determined by the lane's sensors (step 608).

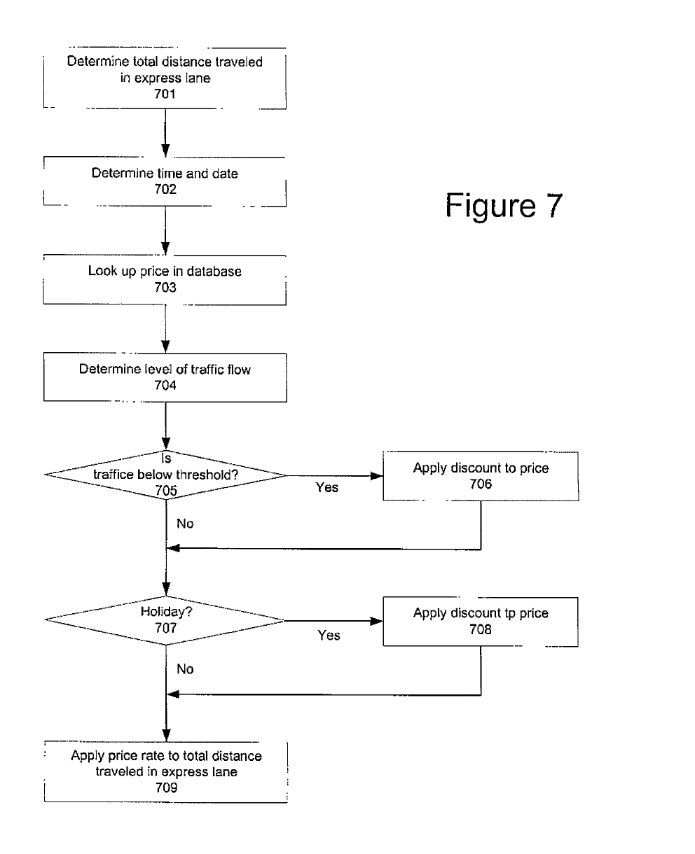

Referring to FIG. 7, a flowchart illustrating the process of calculating user fees for the express lane is depicted in accordance with the present invention. Calculating the user fee begins by determining the total distance traveled within the express lane (step 701). Totaling a given driver/vehicle's use of the express lane will likely be done at set time periods (e.g. daily).

After the total distance traveled by the vehicle is determined, the system next determines the time and date of the road usage (step 702) and looks up the appropriate user fee for those times and dates (step 703). Because traffic flow varies considerably between different times of the day and between different days of the week, the need to relieve congestion also varies. For example, Monday morning rush hour (i.e. 8:00 AM) might have an extremely high demand for road services, as thousands of drivers attempt to get to work at a similar time. Therefore, those drivers wanting to use an uncrowded express lane will have to pay a relatively high user fee. By contrast, traffic flow and congestion is likely to be very light at 11:00 PM on that same Monday. Weekend traffic is also likely to be lighter than during the working week. Therefore, the user fees for express lanes would probably be lower (or nonexistent) during such low traffic periods.

Once the appropriate price rates are determined for the time and date of use, optional discounts may also be applied before calculating the final charge. The system could employ dynamic pricing that is sensitive to current traffic flow, and make changes to user fees in real time. As noted above, price rates for express lanes are determined by projected demand for road services (traffic flow) at particular times and dates. However, if traffic flow happens to fall below that expected level of demand, the user fee for using the express lane may also be temporarily discounted during these times, and then restored to the default level when traffic flow returns to expected levels. Therefore, the system can check the level of traffic flow in the express lane, and possibly surrounding lanes, to see if the traffic is below expected levels for that time and day (step 705). If the traffic flow does fall below the expected level, a discount may be applied to the user fee, as explained above (step 706).

The system may also determine if the express is being used on an official holiday (step 707), and then apply a discount is it is an official holiday (step 708). The optional discount for holidays may also be incorporated into step 702, where all official holidays are taken into account when determining the original price scheme for time and date. It should also be mentioned that holidays may actually require an increase in user fees, rather than a discount. For example, the increased demand for road services on the Labor Day weekend may require an higher user fee in order to maintain optimal traffic flow.

Once all optional discounts are determined and applied to the relevant price schemes, these rates are applied to the total distance that the driver traveled in the express lane during the measured time period, and the total charge is determined (step 709).

Referring back to FIG. 6, after the total charge is calculated, this charge is applied to the driver's account (step 609). Optionally, for drivers that do not have a valid account, the total charge may be transmitted to enforcement officials, who may then add the user fee on top off any fine levied against the driver.

In the case of a road system with multiple express lanes, such as highway 500, the process flow illustrated in FIG. 6 may be used for each separate express lane.

An In-vehicle Information System (IVIS) may also be implemented with the present invention. IVIS is a project funded by the Federal Highway Administration as part of the Driver Vehicle Information Program. Using communications and computing technology, an IVIS provides a variety of information management services intended to make driving safer, easier, and more efficient, including both vehicle control and route navigation.

IVIS is a component of the Advanced traveler Information System (ATIS) program, which provides en-route information to drivers, inside the vehicle. Examples of the type of information provided to drivers include navigation, route guidance, motorist services, real-time traffic conditions, safety advisories/warnings, and regulatory information.

The information provided by IVIS and ATIS complements the present invention in helping to reduce road congestion. In addition, information specific to the present invention may also be added to IVIS/ATIS. For example, information about user fees for different express lanes may be combined with information related to navigation/routing and traffic conditions. In this way, drivers may optimize their travel based on economic decisions, in addition to distance and traffic patterns.

The present invention not only provides a way for government officials to partially relieve congestion on public roads, but it also provides the technical means by which private road systems may one day be implemented, which is likely to be a greater economic necessity in the coming decades.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for managing traffic flow on a road system, the method comprising:
associating a user fee with a particular lane on a road;
identifying a vehicle within the lane by means of radio frequency identification (RFID), wherein a RFID reader interrogates a transponder within the vehicle, and wherein RFID is used to track the vehicle while the vehicle is traveling within the lane;
associating the vehicle with a user account; and
charging the user fee directly to the user account.

2. The method according to claim 1, further comprising:
alerting enforcement officials if the vehicle cannot be associated with a valid user account.

3. The method according to claim 1, wherein RFID readers are placed in the surface of the road at set distance intervals.

4. The method according to claim 1, wherein the user fee is in proportion to the total distance a vehicle travels within the lane.

5. The method according to claim 1, wherein the user fee varies with the time of day.

6. The method according to claim 1, wherein the user fee varies with the day of the week.

7. The method according to claim 1, wherein the user fee varies according to current traffic flow.

8. The method according to claim 1, further comprising an in-vehicle information system (IVIS) which provides user fee information to drivers.

9. The method according to claim 9, wherein the IVIS combines user fee information with routing and navigation information.

10. A computer program product in a computer readable medium for use in a data processing system, for managing traffic flow on a road system, the computer program product comprising:
instructions for associating a user fee with a particular lane on a road;
instructions for identifying a vehicle within the lane by means of radio frequency identification (RFID), wherein a RFID reader interrogates a transponder within the vehicle, and wherein RFID is used to track the vehicle while the vehicle is traveling within the lane;
instructions for associating the vehicle with a user account; and
instructions for charging the user fee directly to the user account.

11. The computer program product according to claim 10, further comprising:
instructions for alerting enforcement officials if the vehicle cannot be associated with a valid user account.

12. The computer program product according to claim 10, wherein the user fee is in proportion to the total distance a vehicle travels within the lane.

13. The computer program product according to claim 10, wherein the user fee varies with the time of day.

14. The computer program product according to claim 10, wherein the user fee varies with the day of the week.

15. The computer program product according to claim 10, wherein the user fee varies according to current traffic flow.

16. The computer program product according to claim 10, further comprising instructions for providing in-vehicle user fee information to drivers.

17. The computer program product according to claim 16, wherein the user fee information is combined with navigation and routing information.

18. A system for managing traffic flow on a road system, the system comprising:
a first register which associates a user fee with a particular lane on a road;
a identification component which identifies a vehicle within the lane by means of a radio frequency identification (RFID) reader which interrogates a transponder within the vehicle, wherein RFID is used to track the vehicle while the vehicle is traveling within the lane;
a second register which associates the vehicle with a user account; and
a third register which charges the user fee directly to the user account.

19. The system according to claims 18, further comprising:
an alert mechanism which alerts enforcement officials if the vehicle cannot be associated with a valid user account.

20. The system according to claim 18, wherein RFID readers are placed in the surface of the road at set intervals.

21. The system according to claim 18, further comprising an in-vehicle information system (IVIS) which provides user fee information to drivers.
